(19) United States
(12) Patent Application Publication
(10) Pub. No.: US 2013/0107161 A1
(43) Pub. Date: May 2, 2013

(54) LIQUID CRYSTAL DISPLAY

(71) Applicants: Kwang-Wook CHOI, Cheonan-si (KR); Joo Woan CHO, Asan-si (KR); Seong Sik CHOI, Seoul (KR)

(72) Inventors: Kwang-Wook CHOI, Cheonan-si (KR); Joo Woan CHO, Asan-si (KR); Seong Sik CHOI, Seoul (KR)

(73) Assignee: SAMSUNG ELECTRONICS CO., LTD., Suwon-si (KR)

(21) Appl. No.: 13/438,426

(22) Filed: Apr. 3, 2012

(30) Foreign Application Priority Data
Oct. 26, 2011 (KR) 10-2011-0109849

(51) Int. Cl. G02F 1/13357; B23P 11/00

(52) U.S. Cl. 349/58; 29/428

(57) ABSTRACT

Provided is a liquid crystal display, including: a liquid crystal display panel assembly including a display panel; a light assembly including a light source; a chassis to receive the light assembly; and a pressing plate including a first portion coupled in contact with a portion of the chassis, and a second portion to hold the light source between the pressing plate and the chassis.

### CROSS-REFERENCE TO RELATED APPLICATION

This application claims priority from and the benefit of Korean Patent Application No. 10-2011-0109849 filed on Oct. 26, 2011, which is hereby incorporated by reference for all purposes as if fully set forth herein.

### BACKGROUND OF THE INVENTION

1. Field of Invention

Exemplary embodiments of the present invention relate to a liquid crystal display.

2. Discussion of Background

A liquid crystal display, which is one of the most common types of flat panel displays currently in use, includes two sheets of display panels on which field generating electrodes, such as a pixel electrode and a common electrode, are formed, and a liquid crystal layer that is interposed between those display panels.

In a typical liquid crystal display, the voltage applied across the field generating electrode, which generates an electric field on the liquid crystal layer, determines the orientations of the liquid crystal molecules of the liquid crystal layer and controls the polarization of incident light, thereby finally displaying an image. The liquid crystal display may include a liquid crystal display panel assembly including an electrode, a liquid crystal layer, and the like, a backlight assembly including a light source, and a chassis that constitutes the frame of the liquid crystal display.

Recently, in order to make the overall liquid crystal display slimmer, design efforts have been made to slim down each component of the liquid crystal display, such as the liquid crystal display panel assembly, the backlight assembly, and the chassis.

The above information disclosed in this Background section is only for enhancement of understanding of the background of the invention and therefore it may contain information that does not form the prior art that is already known in this country to a person of ordinary skill in the art.

### SUMMARY OF THE INVENTION

Exemplary embodiments of the present invention provide a liquid crystal display having a slim structure.

Additional features of the invention will be set forth in the description that follows, and in part will be apparent from the description, or may be learned by practice of the invention.

An exemplary embodiment of the present invention provides a liquid crystal display, comprising: a liquid crystal display panel assembly comprising a display panel; a backlight assembly comprising a light source; a bottom chassis to receive the backlight assembly; and a pressing plate comprising a first side portion contacted and coupled with a side portion of the bottom chassis and a second side portion to hold the light source between the pressing plate and the bottom chassis.

An exemplary embodiment of the present invention also provides a method of preparing a chassis to contain a back light assembly, comprising: providing a bottom chassis; bending the bottom chassis along a first line in a first angular direction to form a side portion; bending the bottom chassis along a second line outside the side portion in a second angular direction to form a connection portion between the first and second lines and a body portion; providing a pressing plate; bending the pressing plate along a third line in a third angular direction to form a first side portion; bending the pressing plate along a fourth line outside the first side portion in a fourth angular direction to form a middle portion between the third and fourth lines and a second side portion; and coupling the side portion of the bottom chassis with the first side portion of the pressing plate to form a space with a distance between the pressing plate and the body portion.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a cross-sectional view of a liquid crystal display according to an exemplary embodiment of the present invention.

FIG. 2 is a perspective view of a bottom chassis and a pressing plate according to an exemplary embodiment of the present invention.

FIG. 3A is a cross-sectional view of a bottom chassis and a pressing plate according to an exemplary embodiment of the present invention, and FIG. 3B is a cross-sectional view of a bottom chassis according to related art.

FIG. 4 is a perspective view of a bottom chassis and a pressing plate according to an exemplary embodiment of the present invention.

FIG. 5 is a perspective view of a bottom chassis and a pressing plate according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

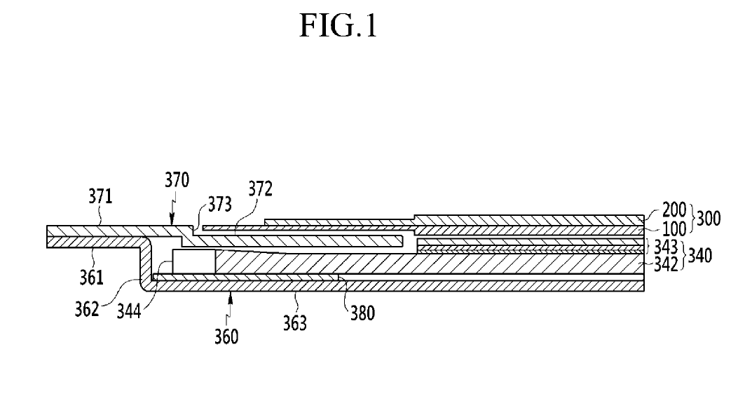

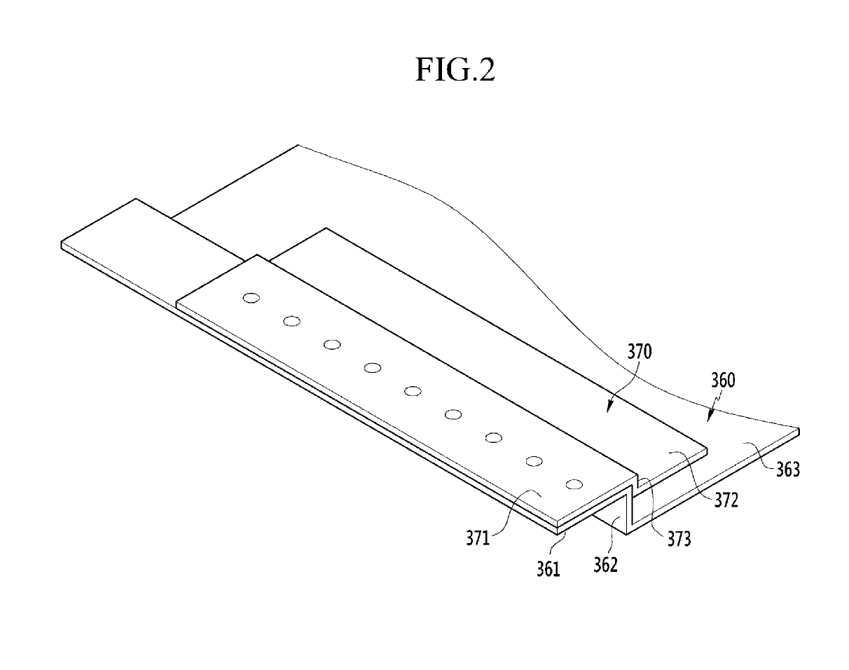

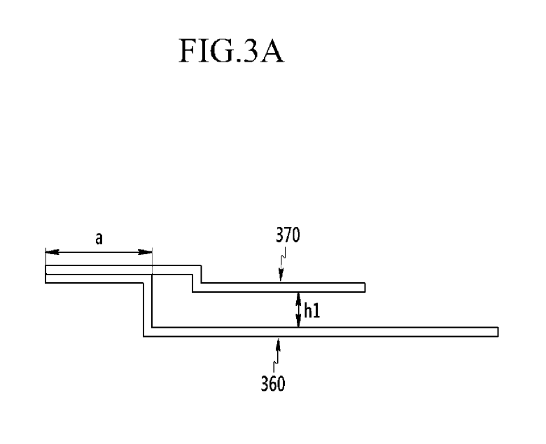

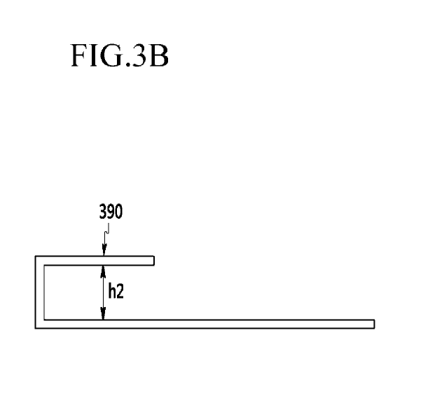

FIG. 1 is a cross-sectional view of a liquid crystal display according to an exemplary embodiment of the present invention, and FIG. 2 is a perspective view of a bottom chassis and a pressing plate according to an exemplary embodiment of the present invention. In addition, FIG. 3A is a cross-sectional view of a bottom chassis and a pressing plate according to an exemplary embodiment of the present invention, and FIG. 3B is a cross-sectional view of a bottom chassis according to related art.

Referring to FIG. 1, in accordance with one exemplary embodiment of the invention, a liquid crystal display may include a liquid crystal display panel assembly 300 for displaying an image, a backlight assembly 340 for generating light, and a bottom chassis 360 for receiving the liquid crystal display panel assembly 300 and the backlight assembly 340.

The liquid crystal display panel assembly 300 includes a first display panel 100, a second display panel 200, and a liquid crystal layer interposed between the first display panel 100 and the second display panel 200.

The first display panel 100 includes a plurality of pixels arranged in a matrix form. The pixel may include a gate line extending in a first direction, a data line extending in a second direction, and a pixel electrode. The pixel may include a thin film transistor which is connected to the gate line, the data line, and the pixel electrode.

A color filter for rendering a color may be disposed on the first display panel 100 or the second display panel 200, and a black matrix for preventing light leakage may be disposed on the first display panel 100 or the second display panel 200. Further, a common electrode corresponding to the pixel electrode may be disposed on the first display panel 100 or the second display panel 200.

The liquid crystal molecules of the liquid crystal layer are moved by the voltages applied to the pixel electrode and the common electrode, thereby changing the polarization of the light supplied from the backlight assembly 340.

The first display panel 100 includes a gate driver for applying a gate signal and a data driver for applying a data signal, and at least one of the gate driver and the data driver may be integrated on the first display panel.

A flexible printed circuit board for applying a control signal to control drivers such as the gate driver and the data driver may be disposed at an end of the first display panel 100. The flexible printed circuit board may include circuit elements such as a timing controller for controlling the timing of control signals and a memory for storing data signals. The flexible printed circuit board may be electrically connected to the first display panel 100 by a connecting member such as a conductive film and the like.

The backlight assembly 340 for supplying light to the first display panel 100 and the second display panel 200 is disposed under or behind the liquid crystal display panel assembly 300.

The backlight assembly 340 includes a light source 344 for generating light, a light guide plate (LGP) 342 for guiding the light along a light path, optical sheets 343 for uniformizing the luminance of the light emitted from the light guide plate 342, and a support plate 380 for supporting the light source 344. The backlight assembly 340 may be fixed or held tight by a mold frame.

The light source 344 may be disposed at at least one of the upper side, the lower side, the left side, and the right side of the light guide plate 342 and fixed or held firmly by the support plate 380. The light source 344 supplies light to the light guide plate 342. Examples of the light source 344 include a cold cathode fluorescent lamp (CCFL), an external electrode fluorescent lamp (EEFL), a light emitting diode (LED), and the like.

The light guide plate 342 may have a light guide pattern for guiding light to the display areas of the first display panel 100 and the second display panel 200, on which an image is displayed.

The optical sheets 343 are disposed between the light guide plate 342 and the liquid crystal display panel assembly 300. The optical sheets 343 may uniformize the luminance of the light supplied from the light guide plate 342 to supply the light to the first display panel 100 and the second display panel 200.

A reflector may be disposed under or behind the light guide plate 342 so as to improve the efficiency of light emission.

Referring to FIG. 1 and FIG. 2, a bottom chassis 360 is disposed under or beneath the backlight assembly 340 and receives the backlight assembly 340 and the liquid crystal display panel assembly 300. One side of the bottom chassis 360 is bent to form an approximately ‘⊂’-shaped structure together with a pressing plate 370. By the ‘⊂’-shaped structure, the light source 344 may be firmly held or fixed. In addition, by the ‘⊂’-shaped structure, the light guide plate 342 may be firmly held or fixed, and drawbacks such as the bending or lifting of the light guide plate 342 may be prevented. Further, the light leakage of the light source 344 due to misalignment of the light source 344 and the light guide plate 342 may be prevented.

The bottom chassis 360 may include a side portion 361, a connection portion 362 bent from the side portion 361, and a body portion 363 bent from the connection portion 362.

The side portion 361 of the bottom chassis 360 and a first side portion 371 of the pressing plate 370 may be coupled with each other. In accordance with one exemplary embodiment, the bottom surface of the first side portion 371 of the pressing plate 370 and the top surface of the side portion 361 of the bottom chassis 360 may be placed in contact with each other. For example, one side of the bottom chassis 360 and one side of the pressing plate 370 may be coupled with each other, by any suitable methods, e.g., by spot welding. The positions, intervals and sizes of spots made by spot welding may be properly adjusted. For example, the spots may be arranged in a zigzag shape or a linear shape. The width “a” by which the side portion 361 of the bottom chassis 360 and the first side portion 371 of the pressing plate 370 are in contact with each other may be determined appropriately, and may be, e.g., about 0.1 mm to about 2.0 mm. The width of the first side portion 371 of the pressing plate 370 may be larger than or similar to the width of the side portion 361 of the bottom chassis 360.

A second side portion 372 of the pressing plate 370, the connection portion 362 of the bottom chassis 360, and the body portion 363 of the bottom chassis 360 may form an approximately ‘⊂’-shaped structure. In this instance, the second side portion 372 of the pressing plate 370 may fix or hold the light source 344 and the light guide plate 342 firmly so that the light source 344 and the light guide plate 342 would not be loose to move.

In accordance with one embodiment, the assembly of the bottom chassis 360 and the pressing plate 370 may be prepared by multiple bending and bonding procedures. For instance, a plate for the bottom chassis 360 is provided, and is subject to a bending process, which includes bending the plate along an appropriate first line in the first angular direction, e.g., is clockwise by a right angle, to form the side portion 361. Additionally, the plate is bent along an appropriate second line, which may be in parallel with the first line, in the second angular direction, e.g., counterclockwise by a right angle, to form the connection portion 362 and the body portion 363. By determining the positions of the first and second lines appropriately, the width of the connection portion 362 may be determined.

Further, a plate for the pressing plate 370 is provided, and is subject to a similar bending process to form the first side portion 371, the middle portion 373, and the second side portion 372. The positions to bend are determined to produce an appropriate width of the middle portion 373. For instance, the widths of the connection portion 362 and the middle portion 373 may be determined to produce a desired space between the body portion 363 and the second side portion 372.

In accordance with one embodiment, the side portion 361 of the bottom chassis 360 is coupled with the first side portion 371 of the pressing plate 370. The coupling may be performed by any suitable methods. For instance, spot welding using laser may be employed to provide a sufficient coupling strength. The number and positions of welded spots may be determined appropriately.

The bottom chassis 360 and the pressing plate 370 may be made of the same material or different kinds of materials. For instance, chassis materials having high strength for their thicknesses may be used. Also, chassis materials that may be subject to spot welding by laser, in particular, may be used. Examples of chassis materials that can be used include metals referred to as SUS, which stands for stainless steel materials according to Japanese Industrial Standards. For instance, SUS304 having high heat resistance may be used. The thickness of the material may be in the range of T0.1-T0.5.

Referring to FIG. 3A, the body portion 363 of the bottom chassis 360 and the second side portion 372 of the pressing plate 370 are separated from each other by a first height h1. Since the bottom chassis 360 and the pressing plate 370 form the approximately ‘⊂’-shaped structure as mentioned above, the first height h1 may be reduced more than in prior art, thereby slimming down the liquid crystal display and holding the light source 344 more firmly. For example, the first height h1 may be approximately 1 mm or less, and specifically, approximately 0.8 mm or less. As shown in FIG. 3A, a middle portion 373 of the pressing plate 370 may be bent to form a crank shape. The bending degree of the pressing plate 370 may be properly adjusted to produce the first height h1 as desired. More specifically, in accordance with one exemplary embodiment, the portions to be bent on the pressing plate 370 may be determined so that a desired first height h1 is produced. For instance, the first height h1 may be the difference between the side widths of the connection portion 362 and the middle portion 373. By adjusting the widths of the connection portion 362 and the middle portion 373, the first height h1 can be easily modified. Further, the first height h1 can be lowered down to a level to facilitate downsizing of the assembly including the chassis and the pressing plate. The downsized assembly can contribute to slimming down the overall liquid crystal display.

In contrast, referring to FIG. 3B, a bottom chassis 390 of related art is bent at necessary portions to form a ‘⊂’-shaped structure having a second height h2. There are technical limitations on how much the second height h2 can be reduced due to issues relating to molding and bending processes when only the bottom chassis 390 is used. As a result, there are limitations on the amount of reduction in the size of the bent portions and thus on slimming down the liquid crystal display. For example, the second height h2 may be approximately 1.4 mm, and it may practically be difficult to reduce the second height h2 to approximately 1 mm or less. When the bottom chassis 390 is subject to a bending process for a very low height, it may be prone to breakage. Further, the ‘⊂’-shaped structure of the bottom chassis 390 of related art may not have enough mechanical strength to hold the back light assembly as firmly as desired.

In accordance with one exemplary embodiment, the ‘⊂’-shaped structure of the bottom chassis 360 and the pressing plate 370 may be fitted at one or more of the upper side, the lower side, the left side, and the right side of the liquid crystal display. The ‘⊂’-shaped structure of the bottom chassis 360 and the pressing plate 370 may be fitted at a position corresponding to the position of the light source 344. For example, when the light source 344 is disposed at the lower side of the liquid crystal display, the ‘⊂’-shaped structure of the bottom chassis 360 and the pressing plate 370 may also be formed at the lower side of the liquid crystal display.

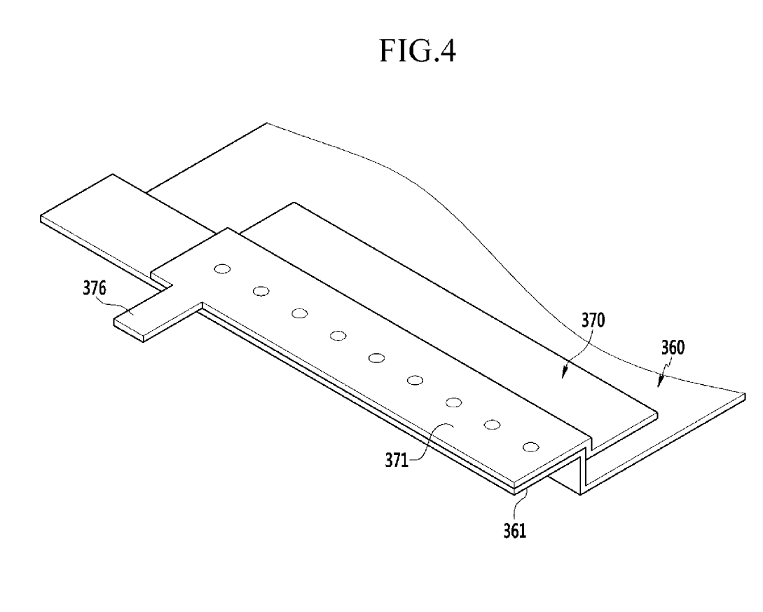

FIG. 4 is a perspective view of a bottom chassis and a pressing plate according to an exemplary embodiment of the present invention.

Referring to FIG. 4, a pressing plate protrusion 376 may be disposed at the first side portion 371 of the pressing plate 370, and may be extended from a portion of the pressing plate 370. The first side portion 371 of the pressing plate 370 and the pressing plate protrusion 376 may be disposed at the same plane. The pressing plate protrusion 376 may have a flange shape and be connected to a set bracket including the configuration of a flexible printed circuit board or the like.

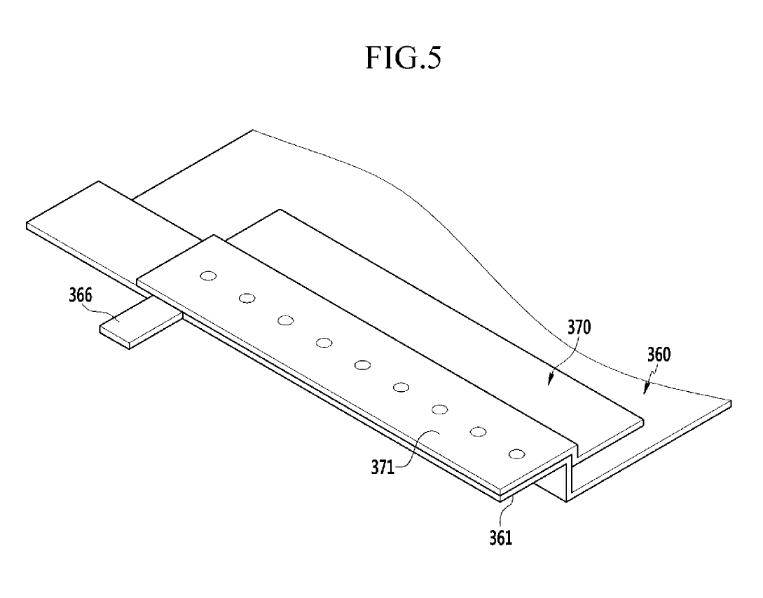

FIG. 5 is a perspective view of a bottom chassis and a pressing plate according to an exemplary embodiment of the present invention.

Referring to FIG. 5, a bottom chassis protrusion 366 is disposed at the side portion 361 of the bottom chassis 360, and may be extended from a portion of the bottom chassis 360. The side portion 361 of the bottom chassis 360 and the bottom chassis protrusion 366 may be disposed on the same plane. The bottom chassis protrusion 366 may have a flange shape and be connected to a set bracket including the configuration of a flexible printed circuit board or the like.

According to an exemplary embodiment of the present invention, it is possible to make the liquid crystal display slim.

While this invention has been described in connection with exemplary embodiments, it is to be understood that the invention is not limited to the exemplary embodiments. It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A liquid crystal display, comprising:
a liquid crystal display panel assembly comprising a display panel;
a light assembly comprising a light source;
a chassis to receive the light assembly; and
a pressing plate comprising a first portion coupled in contact with a portion of the chassis, and a second portion to hold the light source between the pressing plate and the chassis.

2. The liquid crystal display of claim 1, wherein:
the chassis comprises a connection portion bent from the portion of the chassis and a body portion bent from the connection portion.

3. The liquid crystal display of claim 2, wherein:
the second portion of the pressing plate, the connection portion of the chassis, and the body portion of the chassis form a ‘⊂’-shaped structure.

4. The liquid crystal display of claim 1, wherein:
a bottom surface of the first portion of the pressing plate and a top surface of the portion of the chassis are in contact with each other.

5. The liquid crystal display of claim 1, wherein the chassis and the pressing plate are coupled with each other on welded spots.

6. The liquid crystal display of claim 1, wherein:
the light assembly comprises a light guide plate, and the second portion of the pressing plate holds the light guide plate with the chassis.

7. The liquid crystal display of claim 6, wherein:
the pressing plate comprises a bent portion.

8. The liquid crystal display of claim 6, wherein:
the light source is disposed at one or more of an upper side, a lower side, a left side, and a right side of the liquid crystal display panel assembly.

9. The liquid crystal display of claim 8, wherein:
the pressing plate is disposed at a position corresponding to a position of the light source.

10. The liquid crystal display of claim 9, wherein:
the pressing plate comprises a bent portion.

11. The liquid crystal display of claim 1, wherein:
the light source is disposed at one or more of an upper side, a lower side, a left side, and a right side of the liquid crystal display panel assembly.

12. The liquid crystal display of claim 11, wherein:
the pressing plate is disposed at a position corresponding to a position of the light source.

13. The liquid crystal display of claim 12, wherein:
the pressing plate comprises a bent portion.

14. The liquid crystal display of claim 1, wherein:
a distance between the second portion of the pressing plate and the body portion of the chassis is 1 mm or less.

15. The liquid crystal display of claim 1, wherein:
the pressing plate comprises a pressing plate protrusion extending from a portion of the pressing plate, and the pressing plate protrusion is disposed at the first portion of the pressing plate.

16. The liquid crystal display of claim 15, wherein:
the first portion of the pressing plate and the pressing plate protrusion are disposed on the same plane.

17. The liquid crystal display of claim 1, wherein:
the chassis comprises a chassis protrusion extending from a portion of the chassis, and the chassis protrusion is disposed at the portion of the chassis.

18. The liquid crystal display of claim 17, wherein:
the portion of the chassis and the chassis protrusion are disposed on the same plane.

19. A method of manufacturing a chassis to contain a light assembly, comprising:
providing a chassis;
bending the chassis along a first line in a first angular direction to form a portion;
bending the chassis along a second line outside the portion in a second angular direction to form a connection portion between the first and second lines and a body portion;
providing a pressing plate;
bending the pressing plate along a third line in a third angular direction to form a first portion;
bending the pressing plate along a fourth line outside the first portion in a fourth angular direction to form a middle portion between the third and fourth lines and a second portion; and
coupling the portion of the chassis with the first portion of the pressing plate to form a space with a distance between the pressing plate and the body portion.
